(19) United States
(12) Patent Application Publication
(10) Pub. No.: US 2004/0131767 A1
(43) Pub. Date: Jul. 8, 2004

(54) Method for producing a fluorescent material layer

(76) Inventors: Manfred Fuchs, Nurnberg (DE); Erich Hell, Gingen (DE); Detlef Mattern, Erlangen (DE); Bernhard Schmitt, Kups (DE)

Correspondence Address: SCHIFF HARDIN, LLP, PATENT DEPARTMENT, 6600 SEARS TOWER, CHICAGO, IL, 60606-6473, US

(21) Appl. No.: 10/476,679

(22) PCT Filed: Aug. 22, 2002
(86) PCT No.: PCT/DE02/03078

(30) Foreign Application Priority Data
Aug. 24, 2001 (DE) 101 41 522.2

(51) Int. Cl. B05D 5/12

(52) U.S. Cl. 427/99

(57) ABSTRACT

The invention relates to a method for producing a fluorescent material layer, comprising the following steps: a)depositing the fluorescent material layer (4) from the vapour phase on a substrate (3), b) measuring the light yield by local resolution and c) annealing the fluorescent material layer (4) by local resolution at points where the light yield is smaller that a predefined value.

The invention concerns a method to produce a luminophore layer and a device to implement the method.

In the use of halogenides and dopants with different saturation vapor pressure, for example CsI/TlI or CsBr/EuBr₂, the problem ensures that given vaporization from the liquefied material, the compounds with the higher saturation vapor pressure escape more quickly than the compounds with the lower saturation vapor pressure. The dopants are unevenly distributed in the crystals deposited on the substrate. For example, the crystals comprise a higher content of dopants at their surface than inside.

In order to counter this problem, it is known from DE 44 29 013 A1 to measure the layer thickness of the luminophore layer during the vacuum evaporation by means of an x-ray measurement device. Dependent on the measurement result, the vapor deposition rate is regulated to achieve as even a layer thickness as possible and a complete vaporization of the liquefied material.

Furthermore, a method to produce a luminophore layer comprised of CsI:Tl is known from DE 195 16 450 C1. The pressure in the vaporization plant is thereby maintained higher than the saturation vapor pressure of the Tl used, at least during the vapor deposition. With this method, a luminophore layer can produce an improved light efficiency.

The known methods are suitable in particular for vacuum evaporation of compounds formed from alkali halogenides whose saturation vapor pressures are not all too different. However, they are not suitable to produce luminophore layers made of compounds, for example CsBr/EuBr₂ whose saturation vapor pressures differ significantly from one another.

In addition, it is known according to the prior art to “torch” luminophore layers after the vacuum evaporation. The torching effects a compensation of concentration differences of the dopant. An optimal value of the light efficiency or of the storage capacity of the luminophore layer is achieved.—What is disadvantageous is that the waste in this method is high. In addition, the light efficiency is not equally large in all locations, meaning in the x-y direction. In particular given use of the luminophore layer as an x-ray intensifier, it can lead to an unwanted adulteration of the x-ray image. Inasmuch, a variation of the light efficiency of at most 5% with regard to a maximum value of the light efficiency is tolerable.

It is the object of the invention to correct the disadvantages of the prior art. In particular, as universal and simple a method as possible for the production of luminophore layers with a substantially uniform light efficiency in the x-y direction should be specified. A further goal of the invention is to specify a device suitable to implement the method.

This object is achieved via the features of the claims 1 and 12. Functional embodiments arise from the features of the claims 2 through 10 and 13 as well as 14.

According to condition of the invention, a method to produce a luminophore layer is provided with the following steps:

a) deposition of the luminophore layer from the vaporization phase on a substrate,

b) locally resolved measurement of the light efficiency and

c) locally resolved tempering of the luminophore layer at locations at which the light efficiency is less than a predetermined value.

By local resolution, what is meant is a resolution in the x-y direction, meaning in a lateral direction of the luminophore layer. The predetermined value can be, for example, a minimum value of the light efficiency that is necessary for the respective application of the luminophore layer. By luminophore, what is presently meant is a scintillator or a storage luminophore. Such a luminophore can be used for production of an x-ray intensifier, intensifier plates, for x-ray film or in computer-aided radiology.

With the proposed method, a luminophore layer can be produced in a surprisingly simple manner that exhibits at all locations a substantially equal light efficiency. It works the same in luminophore layers which exhibit a different thickness in the x-y direction. The waste can be substantially reduced with the proposed method.

In an advantageous embodiment, the steps lit. b and lit. c are repeated until the light efficiency of the luminophore layer at all locations is at most 10%, preferably at most 5%, less than a predetermined value. Such a luminophore layer can be used in x-ray image intensifiers.—The predetermined value can be a maximum value measured in step lit. b. The light efficiency is matched to the maximum value via locally resolved tempering at the other locations.

In an appropriate manner, in each repetition a first temperature of the locally resolved tempering is chosen higher than in the preceding locally resolved tempering. In each repetition of the locally resolved tempering, the first temperature can be selected 20-50° C. higher. The aforementioned features are based on the realization that the light efficiency of the luminophore can be raised by an increase of the first temperature. At locations of lesser light efficiency, the light efficiency can thus be iteratively increased until it substantially corresponds to the predetermined value. Instead of an increase of the first temperature, it is also possible to vary the hold period in a repetition of the steps lit. b and lit. c. As a matter of course, it is also possible to vary both aforementioned parameters, meaning the first temperature and the hold period, to increase the light efficiency.

According to a further embodiment feature, the entire luminophore layer is tempered at a second temperature in the range of 150-250° C. before the step lit. b. Such a tempering of the entire luminophore layer serves as an increase of the average value of the light efficiency. Local differences in the light efficiency are also thereby significantly compensated. The steps lit. b and lit. c must be repeated only a few times to compensate local differences of the light efficiency. To achieve a uniform distribution of the light efficiency in the x-y direction, it is advisable to select the first temperature in step lit. c higher than the second temperature.

A heating array formed from a plurality of heating elements is advantageously used for locally resolved tempering, whereby each heating element is adjusted to a first temperature calculated dependent on a previous location-dependent measured value of the light efficiency. When the light efficiency at the respective heating element-affecting location is below the predetermined value, the heating element is heated to a previously calculated first temperature and maintained at this temperature for a predetermined hold period. If, at the respective location affected by the heating element, the light efficiency already corresponds to the predetermined value, the heating element is not heated, meaning its temperature is adjusted to surrounding temperature.

It has proven to be advisable to use a scanner or a CCD camera for locally resolved measurements of the light efficiency. The scanner can be an LED scanner. Using such a scanner or a CCD camera, the distribution of the light efficiency in the x-y direction can ensue without mechanical scanning of the luminophore layer. This means the distribution of the light efficiency is detected at the same moment and subsequently evaluated. In the evaluation, the first temperature output signal calculated for each of the heating elements for the subsequent tempering step. The hold period can be predetermined fixed or likewise individually predetermined as a result of the evaluation. The evaluation can ensue automatically by means of a predetermined computer program, such that the steps lit. b and lit. c are repeated until a predetermined distribution of the light efficiency has been achieved.

According to a further embodiment feature, the luminophore layer is produced from a doped alkali halogenide. The doped alkali halogenide can be selected from the following group: CsBr:Eu, CsI:Tl, CsI:Na, RbBr:Eu, RbBr:Tl. Naturally, the luminophore layer can also be produced from other alkali halogenides suitable for vacuum evaporation.

To implement the inventive method, a device is provided, according to further condition of the invention, with a device for locally resolved measurement of the light efficiency of a luminophore layer, a heating array formed from a plurality of individually controllable heating elements, and a device to control the heating elements dependent on the measured value of the light efficiency.

It is possible with the proposed device to largely automatically produce luminophore layers with a uniform light efficiency in the x-y direction.

As a further component of the device, an x-ray source is functionally provided to irradiate the luminophore layer. After the irradiation of the luminophore layer, the distribution of the light efficiency in the x-y direction can be measured by means of the device for locally resolved measurement of the light efficiency. The device for locally resolved measurement of the light efficiency can comprise a CCD camera or a scanner. The scanner can be an LED scanner. Such a device enables a quick locally-resolved measurement of the distribution of the light efficiency. The proposed device can be automatically controlled by means of a computer program.

An exemplary embodiment of the invention is subsequently more closely explained using the drawing. Thereby shown are:

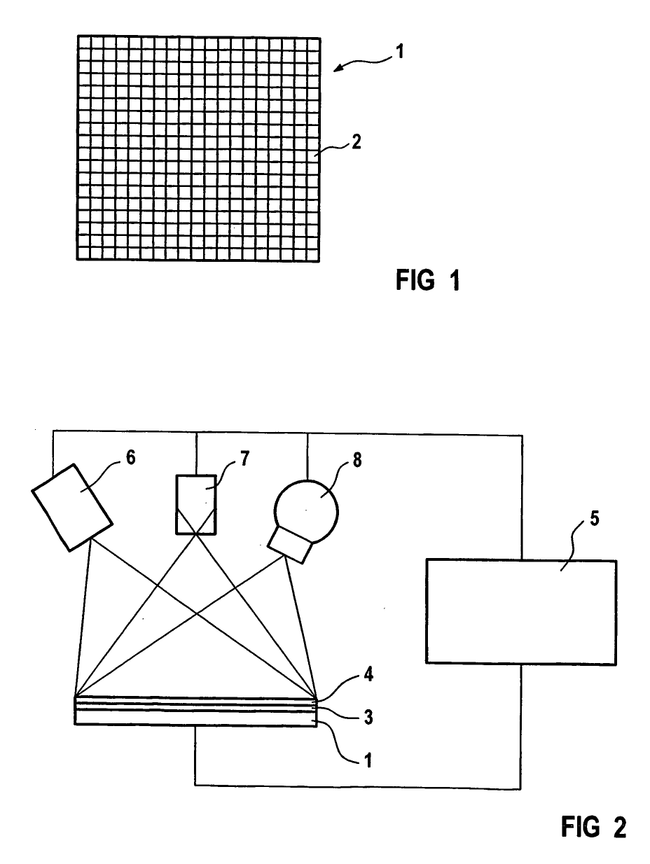

FIG. 1 a plan view of a heating array and

FIG. 2 a schematic view of the most important components of the device.

FIG. 1 shows a heating array 1. The heating array 1 comprises a plurality of heating elements 2 that are arranged in rows and columns. The heating elements 2 are preferably resistance heating elements. Their edge length can be 1 to 5 cm. Each of the heating elements 2 can be individually adjusted to a predetermined temperature.

FIG. 2 shows a device for locally resolved tempering of a luminophore plate that is formed from a substrate 3 and a luminophore layer 4 applied thereto. The luminophore can, for example, be CsBr:Eu. The luminophore plate lies on the heating array 1. The heating elements 2 of the heating array 1 are connected with a control and regulation device 5. Likewise connected with the control and regulation device 5 is a scanner 6 (preferably an LED surface scanner), an infrared camera 7 and an x-ray tube 8. Instead of the scanner 6, a CCD camera can also be provided.

After placing the luminophore plate on the heating array 1, the heating array 1 is heated to a uniform temperature of, for example, 170° C. by means of the control and regulation device 5. The temperature is maintained for a predetermined time, for example one hour (is this right?). The temperature can by regulated by means of the infrared camera 7 and the control and regulation device 5. By means of the first tempering step, the light efficiency of the luminophore layer 4 is brought to a predetermined minimum value that is necessary for the respective application.

After the cooling of the luminophore layer 3, it is irradiated by means of the x-ray tube 8 for a predetermined time with a predetermined energy. The luminescence light thereby generated is detected by the scanner 6. The light efficiency for each surface element of the luminophore layer corresponding to a heating element 2 is detected by means of the control and regulation device 5. The determined light efficiency is compared with a predetermined value. If a difference exists between the predetermined value and the determined value, a temperature is calculated for the appertaining heating element 2.

The heating elements 2 are subsequently heated according to the calculated tempering temperature and maintained at the tempering temperature for a predetermined hold period. The regulation of the tempering temperature ensues in turn by means of the infrared camera 7 and the control and regulation device 5.

After the cooling of the luminophore plate, this is irradiated again with x-ray radiation by means of the x-ray tube 8. The distribution of the light efficiency in the x-y direction is newly detected using the scanner 6 and evaluated with the control and regulation device 5. Those surface elements of the luminophore layer 3 which still exhibit a difference from the predetermined value are heated in a further pass by means of the heating elements 2 associated with them. The tempering temperature is thereby preferably selected higher than the tempering temperature in the preceding pass.

The previously specified method is repeated until a predetermined maximum tempering temperature is achieved. The maximum tempering temperature is dependent on the composition of the luminophore.

With the proposed method, a luminophore plate can be simply and quickly produces whose luminophore layer exhibits a uniform light efficiency in the x-y direction. The light efficiency varies a maximum of up to 5% over the surface.

1. Method to produce a luminophore layer (4) with the following steps:
a) deposition of the luminophore layer (4) from the vaporization phase on a substrate (3),
b) locally resolved measurement of the light efficiency and
c) locally resolved tempering of the luminophore layer (4) at locations at which the light efficiency is less than a predetermined value.

2. Method according to claim 1, whereby the steps lit. b and lit. c are repeated until the light efficiency of the luminophore layer (4) at all locations is at most 10%, preferably at most 5%, less than the predetermined value.

3. Method according to claim 1 or 2, whereby the predetermined value is a maximum value measured in the step lit. b.

4. Method according to any of the preceding claims, whereby in each repetition a first temperature of the locally resolved tempering is selected higher than in the preceding locally resolved tempering.

5. Method according to any of the preceding claims, whereby the first temperature in each repetition of the locally resolved tempering is selected 20 to 50° C. higher.

6. Method according to any of the preceding claims, whereby the entire luminophore layer (4) is tempered at a second temperature in the range of 150 to 250° C. before the step lit. b.

7. Method according to any of the preceding claims, whereby the first temperature in step lit. c is selected higher than the second temperature.

8. Method according to any of the preceding claims, whereby for locally resolved tempering a heating array (1) formed from a plurality of heating elements (2) is used, whereby each heating element (2) is adjusted to a first temperature calculated dependent on a previous locally resolved measured value of the light efficiency.

9. Method according to any of the preceding claims, whereby a scanner (6) or a CCD camera is used for locally resolved measurement of the light efficiency.

10. Method according to any of the preceding claims, whereby the luminophore layer (4) is produced from a doped alkali halogenide.

11. Method according to claim 10, whereby the doped alkali halogenide is selected from the following group: CsBr:Eu, CsI:Tl, CsI:Na, RbBr:Eu, RbBr:Tl.

12. Device to implement the method according to any of the preceding claims, with a with the [sic] device (6) for locally resolved measurement of the light efficiency of a luminophore layer (4), a heating array (1) formed from a plurality of individually controllable heating elements (2), and a device (5) to control the heating elements (2) dependent on the measured values of the light efficiency.

13. Device according to claim 12, whereby an x-ray source (8) is provided to iradiate [sic] the luminophore layer (4).

14. Device according to claim 12 or 13, whereby the device (6) comprises a CCD camera or a scanner with LED elements for locally resolved measurement of the light efficiency.
